(19) United States
(12) Patent Application Publication
(10) Pub. No.: US 2023/0357069 A1
(43) Pub. Date: Nov. 9, 2023

(54) APPARATUS AND METHOD FOR CUTTING GLASS LAMINATED SUBSTRATE

(71) Applicant: CORNING INCORPORATED, CORNING, NY (US)

(72) Inventors: Tae-hyo Park, Seoul (KR); Jeong Hwan Shin, Gyeonggi-do (KR)

(21) Appl. No.: 18/017,462

(22) PCT Filed: Jul. 28, 2021
(86) PCT No.: PCT/US2021/043392

§ 371 Date: Jan. 23, 2023

(30) Foreign Application Priority Data
Jul. 31, 2020 (KR) 10-2020-0096396

(51) Int. Cl. C03B 33/07; B28D 1/24; C03B 33/03; C03B 33/10

(52) U.S. Cl. CPC C03B 33/074; B28D 1/24; C03B 33/03; C03B 33/105

(57) ABSTRACT

Provided is an apparatus for cutting a glass laminated substrate including a glass layer laminated on a substrate and having a first surface, which is a surface of the glass laminated substrate closer to the glass layer, and a second surface, which is a surface that is opposite the first surface. The apparatus includes a support configured to support the glass laminated substrate, a first cutter provided to cut the glass layer from the first surface of the glass laminated substrate, and a second cutter provided to cut the substrate from the first surface of the glass laminated substrate.

### CROSS-REFERENCE TO RELATED APPLICATION

This application claims the benefit of priority under 35 U.S.C. § 371 of International Application No. PCT/US2021/043392, filed on Jul. 28, 2021, which claims the benefit of Korean Patent Application No. 10-2020-0096396, filed on Jul. 31, 2020, in the Korean Intellectual Property Office, the disclosure of each of which is incorporated herein in its entirety by reference.

### BACKGROUND

### 1. Field

One or more embodiments relate to apparatuses and methods for cutting a glass laminated substrate, and more particularly, to an apparatus and method for cutting a glass laminated substrate, by which generation of glass chips or debris and damage to a glass layer may be reduced.

### 2. Description of the Related Art

Glass laminated substrates may be cut using various techniques such as laser, a CNC router, and a water jet. These existing techniques of cutting glass laminated substrates require a large and expensive apparatus and a complicated procedure. Accordingly, there is a demand for a cutting method that enables reductions in damage to a glass layer and in contamination due to glass chips or debris during cutting of a glass laminated substrate.

### SUMMARY

One or more embodiments include an apparatus for cutting a glass laminated substrate, by which generation of glass chips or debris and damage to a glass layer may be reduced.

One or more embodiments include a method of cutting a glass laminated substrate, by which generation of glass chips or debris and damage to a glass layer may be reduced.

Additional aspects will be set forth in part in the description which follows and, in part, will be apparent from the description, or may be learned by practice of the presented embodiments of the inventive concept.

According to one or more embodiments, an apparatus for cutting a glass laminated substrate including a glass layer laminated on a substrate and having a first surface, which is a surface of the glass laminated substrate closer to the glass layer, and a second surface, which is a surface that is opposite the first surface, the apparatus including a support configured to support the glass laminated substrate, a first cutter provided to cut the glass layer from the first surface of the glass laminated substrate, and a second cutter provided to cut the substrate from the first surface of the glass laminated substrate. The first cutter may be configured to form a first groove in the first surface, and the second cutter may be configured to form a second groove in the second surface. The first cutter and the second cutter may be configured such that an overall width of the first groove is greater than a width of the second groove.

According to some embodiments, the first cutter may be configured such that the first groove is formed to be a single groove having a first width, and the second cutter may be configured such that the second groove is formed to have a second width that is less than the first width and the second width is completely overlapped by the first width. The first cutter and the second cutter may be arranged on opposite sides of the glass laminated substrate, respectively.

According to some embodiments, the first cutter and the second cutter may be configured to translate in a translation direction relative to the glass laminated substrate, and the first cutter may be positioned ahead of the second cutter in the translation direction.

According to some embodiments, the first cutter and the second cutter may be configured to translate in a translation direction relative to the glass laminated substrate, and the first cutter may be configured to translate with the second cutter in the translation direction while being substantially arranged with the second cutter in a direction perpendicular to the first surface.

According to some embodiments, the first cutter may be configured such that the first groove is formed to have a sidewall that is inclined with respect to the first surface. The first cutter may be a diamond wheel cutter.

According to some embodiments, the first cutter may include a first sub-cutter configured to form a first sub-groove and a second sub-cutter configured to form a second sub-groove, and the first cutter and the second cutter may be configured such that the first sub-groove and the second sub-groove extend parallel to each other. The second cutter may be configured such that the second groove is formed to be overlapped by at least a portion of the first sub-groove and at least a portion of the second sub-groove.

According to some embodiments, the first sub-cutter and the second sub-cutter may be configured to advance side by side at the same position with respect to a direction in which the first cutter proceeds. According to some embodiments, the first sub-cutter and the second sub-cutter may be configured to advance side by side at different positions with respect to a direction in which the first cutter proceeds. The first cutter and the second cutter may be configured to translate in a translation direction with respect to the glass laminated substrate, and the second cutter may be positioned behind the first sub-cutter and the second sub-cutter in the translation direction.

According to some embodiments, relative positions of the first cutter and the second cutter may be maintained constant while both the first cutter and the second cutter are cutting the glass laminated substrate.

According to some embodiments, the first cutter may be configured to rotate at a rotation speed of about 5000 RPM or less, and a relative speed of the first cutter and the glass laminated substrate may be 2.3 m/minutes or less.

According to one or more embodiments, a method of cutting a glass laminated substrate including a glass layer laminated on a substrate and having a first surface, which is a surface of the glass laminated substrate closer to the glass layer, and a second surface, which is a surface that is opposite the first surface includes providing the glass laminated substrate onto a support, forming a first groove from the first surface such that an overall width of the first groove is a first width, and forming a second groove from the second surface, the second groove having a second width, wherein the first width is greater than the second width.

According to some embodiments, the second groove may be formed such that the second width is completely overlapped by the first width. According to some embodiments, the first groove may include a first sub-groove and a second sub-groove extending parallel to each other, and the first width may be a distance between two sidewalls that are farthest from each other from among both sidewalls of the first sub-groove and both sidewalls of the second sub-groove. The second groove may be formed to be overlapped by at least a portion of the first sub-groove and at least a portion of the second sub-groove.

According to some embodiments, the forming of the first groove may be performed simultaneously with the forming of the second groove. The forming of the first groove may temporally overlap the forming of the second groove. A starting time point of the forming of the first groove may be earlier than a starting time point of the forming of the second groove.

### BRIEF DESCRIPTION OF THE DRAWINGS

The above and other aspects, features, and advantages of certain embodiments of the inventive concept will be more apparent from the following description taken in conjunction with the accompanying drawings, in which:

FIG. 1 is a schematic view of a cross-section of a glass laminated substrate;

FIG. 2 is a schematic view of a cutting apparatus for cutting a glass laminated substrate, according to an embodiment of the present disclosure;

FIG. 3A is a side view illustrating cutting of a glass laminated substrate by a cutter of a cutting apparatus for cutting a glass laminate substrate, according to an embodiment of the present disclosure;

FIG. 3B is a cross-sectional view illustrating a cross-section that is parallel to an xz plane at a position y1 of FIG. 3A;

FIG. 4A is a side view illustrating cutting of a glass laminated substrate by a cutter of a cutting apparatus for cutting a glass laminate substrate, according to another embodiment of the present disclosure;

FIG. 4B is a cross-sectional view illustrating a cross-section that is parallel to an xz plane at a position y1 of FIG. 4A;

FIG. 4C is a cross-sectional view illustrating a cross-section that is parallel to an xz plane at a position y2 of FIG. 4A;

FIG. 5A is a side view illustrating cutting of a glass laminated substrate by a cutter of a cutting apparatus for cutting a glass laminate substrate, according to another embodiment of the present disclosure;

FIG. 5B is a cross-sectional view illustrating a cross-section that is parallel to an xz plane at a position y1 of FIG. 5A;

FIG. 5C is a cross-sectional view illustrating a cross-section that is parallel to an xz plane at a position y2 of FIG. 5A;

FIG. 6A is a side view illustrating cutting of a glass laminated substrate by a cutter of a cutting apparatus for cutting a glass laminate substrate, according to another embodiment of the present disclosure;

FIG. 6B is a cross-sectional view illustrating a cross-section that is parallel to an xz plane at a position y11 of FIG. 6A;

FIG. 6C is a cross-sectional view illustrating a cross-section that is parallel to an xz plane at a position y12 of FIG. 6A;

FIG. 7A is a side view illustrating cutting of a glass laminated substrate by a cutter of a cutting apparatus for cutting a glass laminate substrate, according to another embodiment of the present disclosure; and

FIG. 7B is a cross-sectional view illustrating a cross-section that is parallel to an xz plane at a position y2 of FIG. 7A.

### DETAILED DESCRIPTION

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “one or more of,” when preceding a list of elements, modify the entire list of elements and do not modify the individual elements of the list.

Hereinafter, the inventive concept will be described more fully with reference to the accompanying drawings, in which exemplary embodiments of the inventive concept are shown. The embodiments of the inventive concept may, however, be embodied in many different forms and should not be construed as limited to the exemplary embodiments set forth herein. Rather, these embodiments are provided so that the inventive concept will be thorough and complete, and will fully convey the scope of the inventive concept to those skilled in the art. Like numbers refer to like elements throughout the specification. Various elements and regions illustrated in the drawings are schematic in nature. Thus, the inventive concept is not limited to relative sizes or intervals illustrated in the accompanying drawings.

While such terms as “first,” “second,” etc., may be used to describe various components, such components must not be limited to the above terms. The above terms are used only to distinguish one component from another. For example, a first component discussed below could be termed a second component, and similarly, a second component may be termed a first component without departing from the teachings of the inventive concept.

The terminology used herein is for the purpose of describing particular embodiments only, and is not intended to limit the inventive concept. An expression used in the singular encompasses the expression of the plural, unless it has a clearly different meaning in the context. It will be understood that the terms “comprises” and/or “comprising,” when used in this specification, specify the presence of stated features, integers, steps, operations, elements, components, and/or groups thereof, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

When a certain embodiment may be implemented differently, a specific process order may be performed differently from the described order. For example, two consecutively described processes may be performed substantially at the same time or performed in an order opposite to the described order.

As such, variations from the shapes of the illustrations as a result, for example, of manufacturing techniques and/or tolerances, are to be expected. Thus, embodiments of the inventive concept should not be construed as being limited to the particular shapes of regions illustrated herein but are to include deviations in shapes that result, for example, from manufacturing. As used herein, the term “and/or” includes any and all combinations of one or more of the associated listed items. Term “substrate” used in this specification may mean a substrate itself, or a stacked structure including a substrate and a layer or film formed on a surface of the substrate. Term “a surface of a substrate” used in this specification may mean an exposed surface of a substrate or an outer surface of a layer or film formed on the substrate.

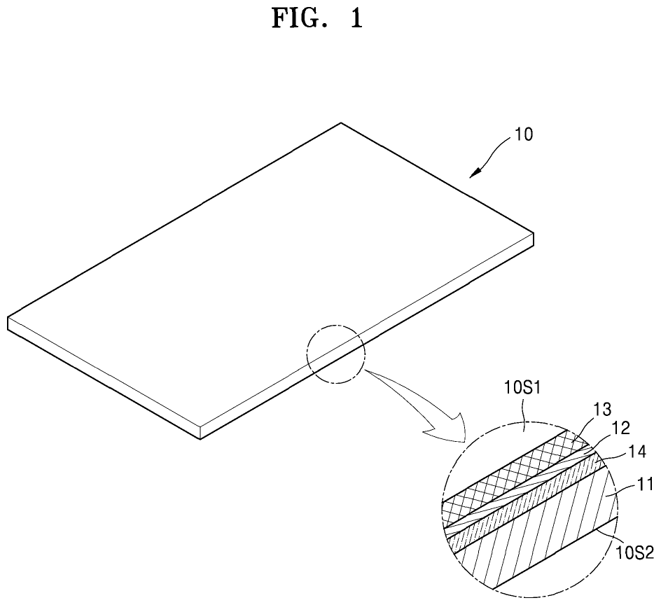

FIG. 1 is a schematic view of a cross-section of a glass laminated substrate 10.

Referring to FIG. 1, the glass laminated substrate 10 includes a substrate 11, a glass layer 13 laminated on the substrate 11, and an adhesion layer 12 for laminating the glass layer 13 on the substrate 11.

The substrate 11 may be formed of, but is not limited to, metal, wood, an inorganic material, an organic material, or a combination thereof. According to some embodiments, the substrate 11 may include, but is not limited to, a high pressure laminate (HPL), a paint-coated metal (PCM), a medium density fiberboard (MDF), a vinyl-coated metal (VCM), or steel.

The glass layer 13 may include, but is not limited to, borosilicate, aluminosilicate, boroaluminosilicate, alkali borosilicate, alkali aluminosilicate, alkali boroaluminosilicate, soda lime, or a combination thereof. A thickness of the glass layer 13 may be in the range of, for example, about 0.1 μm to about 2.0 μm.

The adhesion layer 12 may fix the substrate 11 and the glass layer 13 and couple the substrate 11 and the glass layer 13 to each other. For example, the adhesion layer 12 may be formed of, but is not limited to, a pressure sensitive adhesive (PSA), an optically clear resin (OCR) or an optically clear adhesive (OCA). A thickness of the adhesion layer 12 may be in the range of, for example, about 0.01 mm to about 1.0 mm.

According to some embodiments, the glass laminated substrate 10 may further include an image film layer 14. The image film layer 14 may be a film in which an image layer is printed on a polymer base. For example, the polymer base may include, for example, a polypropylene (PP) film, a polyethylene terephthalate (PET) film, a polystyrene (PS) film, an acrylonitrile butadiene styrene (ABS) resin film, high density polyethylene (HDPE), low density polyethylene (LDPE), polyvinyl chloride (PVC), polyethylene naphthalate, polybutylene terephthalate, polycarbonate (PC), or a laminate film thereof.

The image layer may be a printed layer on which arbitrary contents, such as characters, pictures, and symbols, have been printed. The image layer may be formed by, for example, inkjet printing or laser printing. The image layer may include a pigment component of ink for inkjet printers, or a pigment component of toner for laser printers.

A main surface closer to the glass layer 13 from among two main surfaces of the glass laminated substrate 10 is defined as a first main surface 10S1, and a main surface closer to the substrate 11 from among the two main surfaces of the glass laminated substrate 10 is defined as a second main surface 10S2.

When the glass layer 13 is an uppermost layer of the glass laminated substrate 10, the first main surface 10S1 may be a surface of the glass layer 13. When an additional layer such as a transparent film is provided on the glass layer 13, the first main surface 10S1 may be an exposed surface of the transparent film.

When the substrate 11 is a lowermost layer of the glass laminated substrate 10, the second main surface 10S2 may be a surface of the substrate 11. When an additional layer such as an aluminum thin layer is provided on the substrate 11, the second main surface 10S2 may be an exposed surface of the aluminum thin layer.

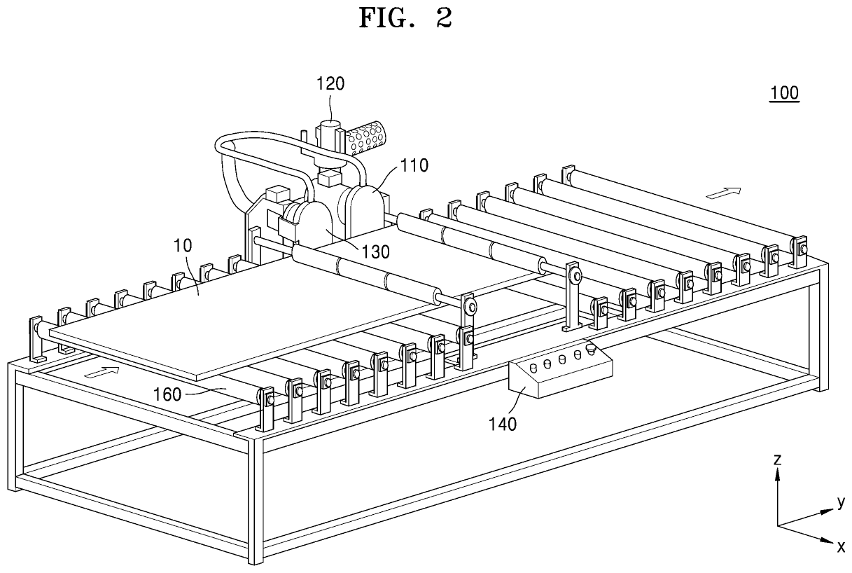

FIG. 2 is a schematic view of a cutting apparatus 100 for cutting a glass laminated substrate, according to an embodiment of the present disclosure. The cutting apparatus 100 of FIG. 2 may be an apparatus for cutting the glass laminated substrate 10 of FIG. 1.

Referring to FIG. 2, the cutting apparatus 100 may include a support 160 capable of supporting the glass laminated substrate 10, and a cutter 110 capable of cutting the glass laminated substrate 10.

The support 160 may have an arbitrary structure capable of appropriately supporting the glass laminated substrate 10. According to some embodiments, the support 160 may be configured to transfer the glass laminated substrate 10 in one direction (for example, a +y direction). According to some embodiments, the support 160 may be configured to fix the glass laminated substrate 10.

According to some embodiments, the cutter 110 is fixed and the glass laminated substrate 10 is transferred by the support 160 in one direction (for example, the +y direction), and thereby the glass laminated substrate 10 may be cut. According to some embodiments, the glass laminated substrate 10 is fixed onto the support 160, and the cutter 110 is moved in a cutting direction (for example, a −y direction), and thereby the glass laminated substrate 10 may be cut. According to some embodiments, the glass laminated substrate 10 is transferred by the support 160 in one direction (for example, the +y direction), and the cutter 110 is moved in the cutting direction (for example, the −y direction), and thereby the glass laminated substrate 10 may be cut.

Operations of the cutter 110 and the support 160 may be controlled by a control device 140. The control device 140 may be configured to control the operations of the cutter 110 and the support 160 and relative movements thereof. Furthermore, the control device 140 may be further configured to control operations of other components (for example, a cooling device 130, etc.) according to the operations of the cutter 110 and the support 160.

According to some embodiments, the cutting apparatus 100 may further include a dust collection device 120 for collecting debris, glass chips, dust, and the like generated during cutting of the glass laminated substrate 10 to prevent contamination of the glass laminated substrate 10. The dust collection device 120 may include, for example, a suction device capable of forming a negative pressure near the cutter 110.

According to some embodiments, the cutting apparatus 100 may further include the cooling device 130 capable of removing heat generated during cutting of the glass laminated substrate 10 in order to prevent the glass laminated substrate 10 and/or the cutter 110 from being damaged due to the heat. The cooling device 130 may be configured to spray cooling water, cooling oil, cooling gas, or the like in order to remove the heat. The cooling gas may be, for example, compressed air.

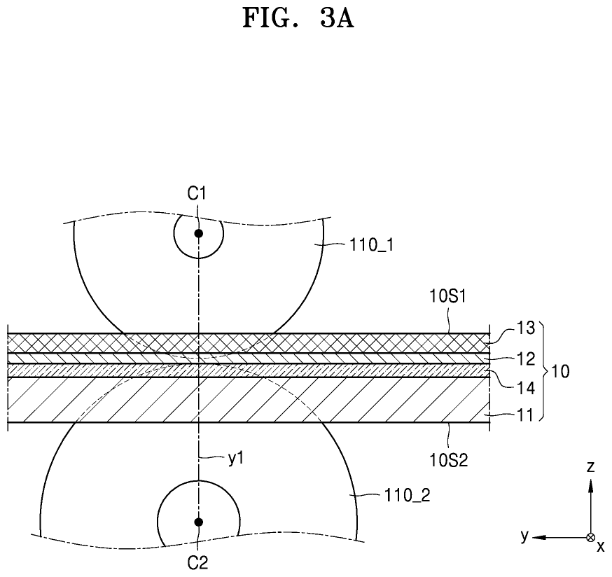

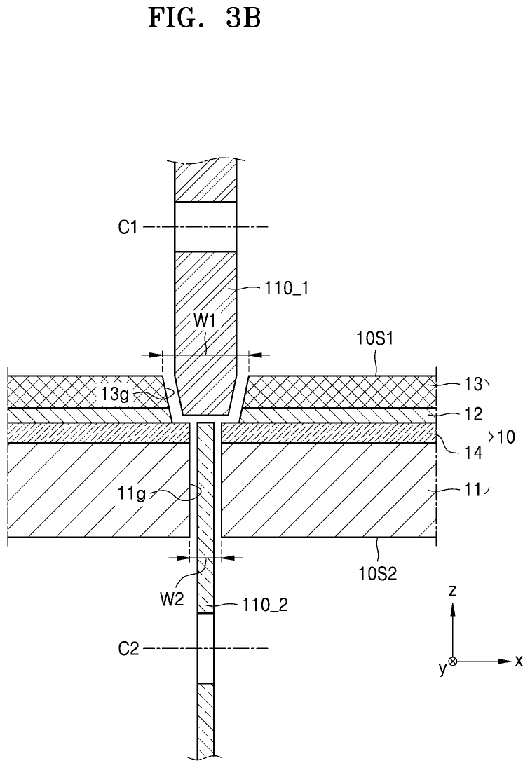

FIG. 3A is a side view illustrating cutting of the glass laminated substrate 10 by the cutter 110 of the cutting apparatus 100 according to an embodiment of the present disclosure. FIG. 3B is a cross-sectional view illustrating a cross-section that is parallel to an xz plane at a position y1 of FIG. 3A.

Referring to FIGS. 3A and 3B, the cutter 110 may include a first cutter 110_1 and a second cutter 110_2. The first cutter 110_1 may be configured to form a first groove 13g in the glass layer 13, the first groove 13g starting from the first surface 1051 of the glass laminated substrate 10. The second cutter 110_2 may be configured to form a second groove 11g in the substrate 11, the second groove 11g starting from the second surface 10S2 of the glass laminated substrate 10.

According to some embodiments, the first cutter 110_1 may be arranged on the first surface 1051 of the glass laminated substrate 10, and the second cutter 110_2 may be arranged on the second surface 10S2 of the glass laminated substrate 10. In other words, the first cutter 110_1 and the second cutter 110_2 may be arranged opposite to each other with respect to the glass laminated substrate 10.

According to some embodiments, the first groove 13g formed by the first cutter 110_1 may divide the glass layer 13. The second groove 11g formed by the second cutter 110_2 may divide the substrate 11.

According to some embodiments, the first cutter 110_1 may form the first groove 13g while proceeding in one direction (+y direction of FIG. 3A) with respect to the glass laminated substrate 10. According to some embodiments, the second cutter 110_2 may form the second groove 11g while proceeding in one direction (+y direction of FIG. 3A) with respect to the glass laminated substrate 10.

According to some embodiments, the first cutter 110_1 and the second cutter 110_2 may form the first groove 13g and the second groove 11g, respectively, while simultaneously translating in one direction (+y direction of FIG. 3A) with respect to the glass laminated substrate 10. At this time, relative positions of the first cutter 110_1 and the second cutter 110_2 may not change.

According to some embodiments, the first cutter 110_1 may be substantially aligned with the second cutter 110_2 in a direction perpendicular to the first surface 10S1. As shown in FIG. 3A, the first cutter 110_1 and the second cutter 110_2 may be aligned with each other in a vertical direction (z direction) at the position y1 in a y direction.

The first groove 13g formed in the glass layer 13 by the first cutter 110_1 may have a first width W1. The first width W1 is defined as a distance between two sidewalls farthest apart from each other from among the sidewalls of the first groove 13g. The second groove 11g formed in the substrate 11 by the second cutter 110_2 may have a second width W2. The second width W2 is defined as a distance between two sidewalls farthest apart from each other from among the sidewalls of the second groove 11g.

The first width W1 is greater than the second width W2. According to some embodiments, the first width W1 may be about 1.1 times to about 5 times, about 1.3 times to about 4 times, about 1.5 times to about 3 times, or about 1.7 times to about 2.5 times the second width W2.

Widths of the first cutter 110_1 and the second cutter 110_2 and positions thereof in the x direction may be configured such that the second width W2 is completely overlapped by the first width W1. In other words, by adjusting the widths of the first cutter 110_1 and the second cutter 110_2, the first width W1 may be greater than the second width W2. By adjusting the positions of the first cutter 110_1 and the second cutter 110_2 in the x direction, the second width W2 in the x direction may be completely overlapped by the first width W1 in the x direction.

In FIG. 3B, the first cutter 110_1 includes one cutting wheel. In some cases, the first cutter 110_1 may include two or more cutting wheels. This will be described later in detail.

The sidewalls of the first groove 13g formed by the first cutter 110_1 may each extend in a direction perpendicular to the first surface 10S1, or may be inclined with respect to the first surface 10S1. According to some embodiments, the first cutter 110_1 may be configured such that the first groove 13g is formed to have a sidewall that is inclined with respect to the first surface 10S1.

Because the first groove 13g has a greater width than the second groove 11g as described above, when the glass laminated substrate 10 is cut, a step may be formed between a portion of the glass laminated substrate 10 cut by the first cutter 110_1 and a portion of the glass laminated substrate 10 cut by the second cutter 110_2. In FIG. 3B, an upper surface of the step is identical with an upper surface of the image film layer 14. However, the upper surface of the step may be identical with an upper surface of the adhesion layer 12 or an arbitrary intermediate level of the entire thickness of the adhesion layer 12.

The first cutter 110_1 may be, for example, a diamond wheel cutter. The diamond wheel cutter has a different structure and a different cutting mechanism from a scoring wheel known in the field of the present technology. The diamond wheel cutter forms a groove along a proceeding path, but the scoring wheel forms no grooves.

The second cutter 110_2 may be appropriately selected according to the material of the substrate 11. For example, when the substrate 11 is a wood such as MDF or HPL, a sawing wheel capable of cutting a wood may be employed. When the substrate 11 is a metal such as a stainless steel, the second cutter 110_2 may be a cubic boron nitride (CBN) wheel.

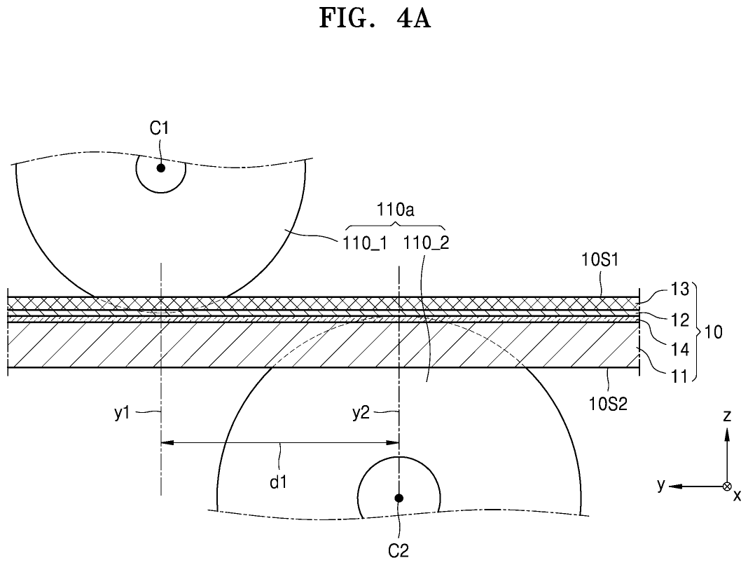

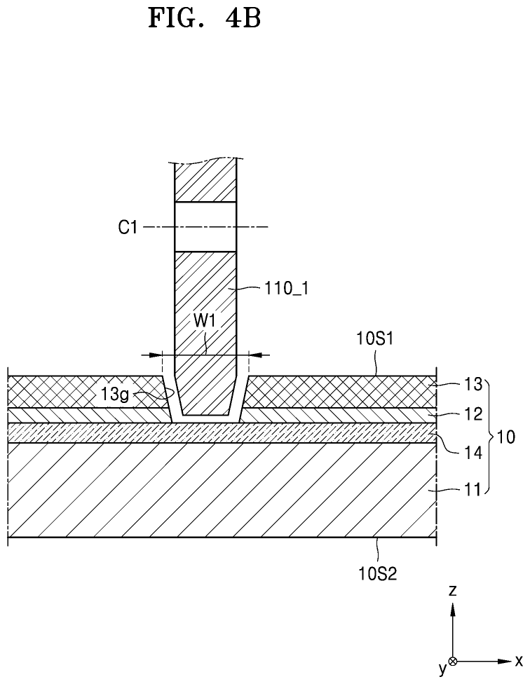

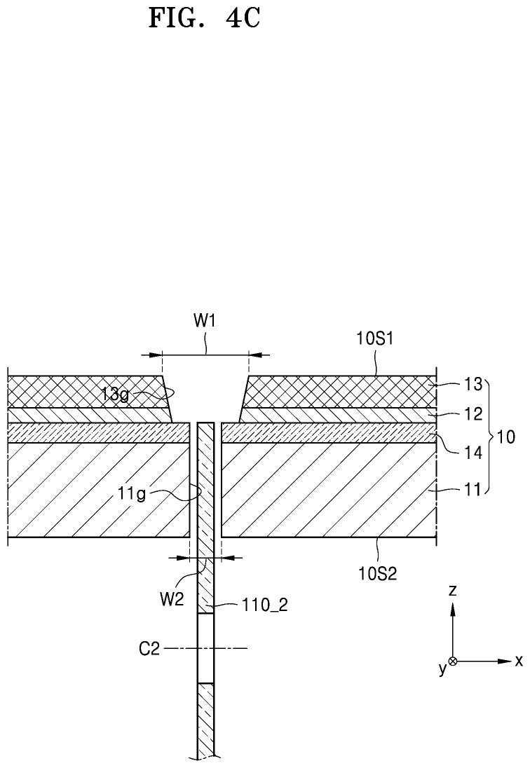

FIG. 4A is a side view illustrating cutting of the glass laminated substrate 10 by a cutter 110a of a cutting apparatus for cutting a glass laminate substrate, according to another embodiment of the present disclosure. FIG. 4B is a cross-sectional view illustrating a cross-section that is parallel to the xz plane at a position y1 of FIG. 4A, and FIG. 4C is a cross-sectional view illustrating a cross-section that is parallel to the xz plane at a position y2 of FIG. 4A.

The cutter 110a according to the embodiment of FIGS. 4A through 4C is different from the cutter 110 described with reference to FIGS. 3A and 3B in that the first cutter 110_1 is arranged at the position y1 in the y direction and the second cutter 110_2 is arranged at the position y2 in the y direction. This difference will now be focused on and described, and the position of each of the first and second cutters 110_1 and 110_2 in the y direction may be represented by a y-direction position of the central axis of each of the first and second cutters 110_1 and 110_2.

Referring to FIGS. 4A through 4C, the first cutter 110_1 and the second cutter 110_2 may be configured to translate in one direction relative to the glass laminated substrate 10. According to some embodiments, a distance d1 between the first cutter 110_1 and the second cutter 110_2 may be maintained constant.

According to some embodiments, the first cutter 110_1 and the second cutter 110_2 may translate, for example, in the +y direction, and the first cutter 110_1 may be positioned ahead in the translation direction compared to the second cutter 110_2.

In particular, referring to FIGS. 4A and 4B, the first groove 13g having the first width W1 may be formed to a predetermined depth from the first surface 10S1 at the position y1 by the first cutter 110_1. The first groove 13g may be formed to divide the glass layer 13. The adhesion layer 12 may be partially or completely cut by the first cutter 110_1.

At the position y1, the glass layer 13 may be cut by the first cutter 110_1 and the substrate 11 may not be cut. At the position y2, the glass layer 13 has already been cut by the first cutter 110_1, and the substrate 11 is being cut by the second cutter 110_2.

Referring to FIGS. 4A and 4C, the second groove 11g having the second width W2, which is less than the first width W1, may be formed in the second surface 10S2 at the position y2 by the second cutter 110_2. The second groove 11g may be formed to divide a remaining portion of the glass laminated substrate 10.

A time point when the first cutter 110_1 starts to form the first groove 13g in the glass laminated substrate 10 may be earlier than a time point when the second cutter 110_2 starts to form the second groove 11g in the glass laminated substrate 10. The first groove 13g and the second groove 11g may be simultaneously formed at different positions in the y direction, between the time point when the second cutter 110_2 starts to form the second groove 11g in the glass laminated substrate 10 and a time point when the first cutter 110_1 completes forming the first groove 13g in the glass laminated substrate 10.

A rotation speed of the first cutter 110_1 may be about 5000 RPM (revolutions per minute) or less. According to some embodiments, the rotation speed of the first cutter 110_1 may be about 2000 RPM to about 5000 RPM, about 2300 RPM to about 5000 RPM, or about 2700 RPM to about 5000 RPM. When the rotation speed of the first cutter 110_1 is too slow, too many glass chips may be generated. When the rotation speed of the first cutter 110_1 is too fast, the lifespan of manufacturing equipment may shorten.

A relative movement speed of the first cutter 110_1 and the glass laminated substrate 10 may be about 2.3 m/min or less. For example, the relative movement speed may be about 0.3 m/min to about 2.3 m/min, about 0.5 m/min to about 2.0 m/min, or about 0.3 m/min to about 2.3 m/min. When the relative movement speed is too fast, a product failure rate may increase. When the relative movement speed is too slow, productivity may be insufficient.

Relative positions of the first groove 13g and the second groove 11g in the x direction may be determined such that the second width W2 is completely overlapped by the first width W1. In other words, in the x direction, the first groove 13g and the second groove 11g may be formed such that both sidewalls of the second groove 11g may be positioned between both sidewalls of the first groove 13g. The relative positions of the first cutter 110_1 and the second cutter 110_2 may be determined considering the relative positions of the first groove 13g and the second groove 11g.

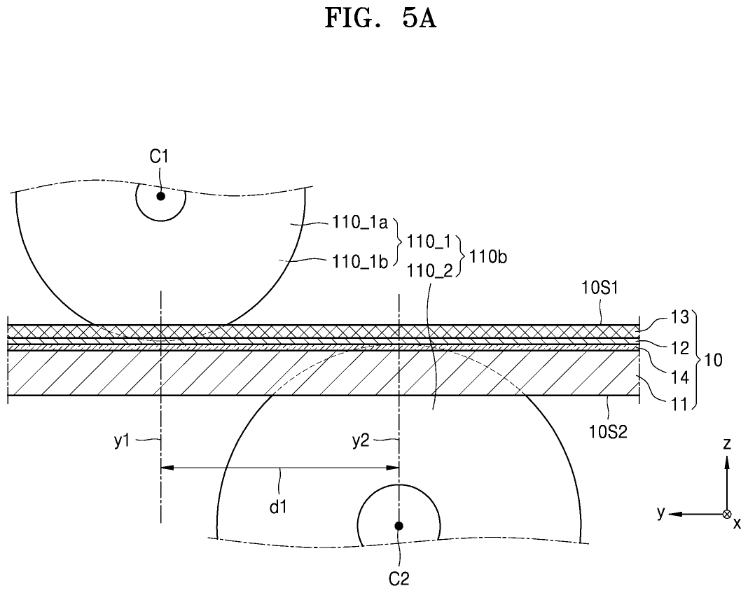

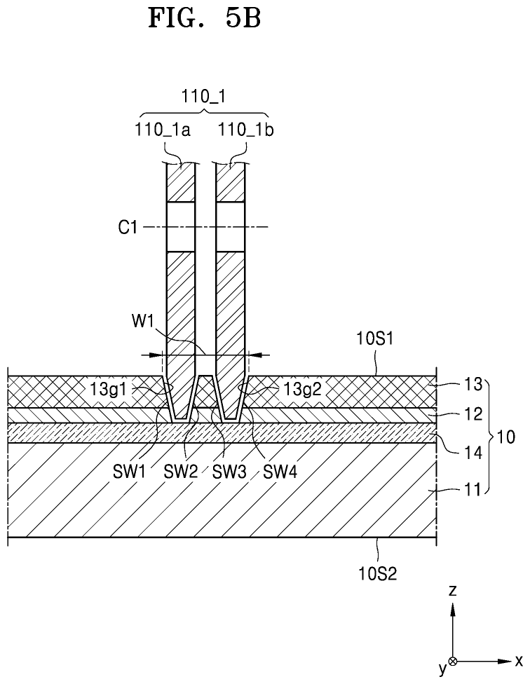

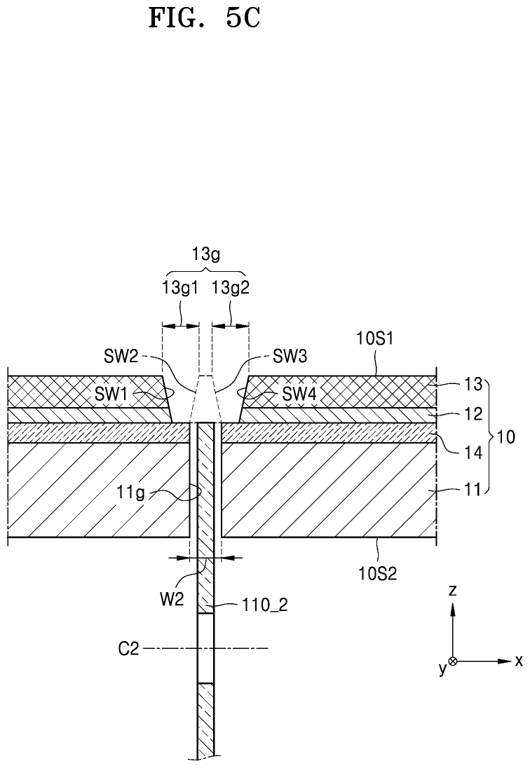

FIG. 5A is a side view illustrating cutting of the glass laminated substrate 10 by a cutter 110b of a cutting apparatus for cutting a glass laminate substrate, according to another embodiment of the present disclosure. FIG. 5B is a cross-sectional view illustrating a cross-section that is parallel to the xz plane at a position y1 of FIG. 5A, and FIG. 5C is a cross-sectional view illustrating a cross-section that is parallel to the xz plane at a position y2 of FIG. 5A.

The cutter 110b according to the embodiment of FIGS. 5A through 5C is different from the cutter 110a described with reference to FIGS. 4A through 4C in that the first cutter 110_1 includes two sub-cutters 110_1a and 110_1b, namely, first and second sub-cutters 110_1a and 110_1b. Accordingly, this difference will now be focused on and described.

Referring to FIGS. 5A through 5C, the first cutter 110_1 may include the first sub-cutter 110_1a and the second sub-cutter 110_1b. The first sub-cutter 110_1a may form a first sub-groove 13g1, and the second sub-cutter 110_1b may form a second sub-groove 13g2.

According to some embodiments, the first sub-cutter 110_1a and the second sub-cutter 110_1b may be located at the same position y1 in the y direction. According to some embodiments, relative positions of the first sub-cutter 110_1a and the second sub-cutter 110_1b may not change while the glass laminated substrate 10 is being cut.

The first sub-groove 13g1 may have a first sidewall SW1 and a second sidewall SW2, and the second sub-groove 13g2 may have a third sidewall SW3 and a fourth sidewall SW4. According to some embodiments, the first, second, third, and fourth sidewalls SW1, SW2, SW3, and SW4 may be inclined with respect to the first surface 10S1. A width of the first sub-groove 13g1 may be defined as a distance between the first sidewall SW1 and the second sidewall SW2, and may be less than the second width W2. A width of the second sub-groove 13g2 may be defined as a distance between the third sidewall SW3 and the fourth sidewall SW4, and may be less than the second width W2.

The first sub-groove 13a1 and the second sub-groove 13a2 may each extend in one direction, for example, the +y direction, parallel to each other. To this end, the first sub-cutter 110_1a and the second sub-cutter 110_1b may be arranged parallel to each other at an appropriate distance, and may translate relative to the glass laminated substrate 10.

The second cutter 110_2 may be configured to form the second groove 11g having the second width W2 in the substrate 11, the second groove 11g starting from the second surface 10S2 of the glass laminated substrate 10. While the second groove 11g is being formed, the relative positions of the first cutter 110_1 and the second cutter 110_2 may not change.

In the x direction, the second groove 11g may be overlapped by at least a portion of the first sub-groove 13a1 and at least a portion of the second sub-groove 13a2. To this end, thickness of the first sub-cutter 110_1a and the second sub-cutter 110_1b and an interval therebetween, a thickness of the second cutter 110_2, and relative positions of the first cutter 110_1 and the second cutter 110_2 in the x direction may be determined.

Referring to FIGS. 5A and 5B, at the position y1, the first sub-groove 13g1 and the second sub-groove 13g2 may be formed to have a predetermined depth from the first surface 10S1 by the first sub-cutter 110_1a and the second sub-cutter 110_1b, respectively. The first sub-groove 13g1 and the second sub-groove 13g2 may be formed to divide the glass layer 13. The adhesion layer 12 may be partially or completely cut by the first sub-cutter 110_1a and the second sub-cutter 110_1b.

The first groove 13g including the first sub-groove 13a1 and the second sub-groove 13a2 may have the first width W1. The first width W1 is defined as a distance between two sidewalls farthest apart from each other from among the sidewalls of the first, second, third, and fourth sidewalls SW1, SW2, SW3, and SW4. Accordingly, in FIG. 5B, the first width W1 is defined as a distance between the first sidewall SW1 and the fourth sidewall SW4.

At the position y1, the glass layer 13 may be cut by the first cutter 110_1 and the substrate 11 may not be cut. At the position y2, the glass layer 13 has already been cut by the first cutter 110_1, and the substrate 11 is being cut by the second cutter 110_2.

Referring to FIGS. 5A and 5C, the second groove 11g having the second width W2, which is less than the first width W1, may be formed in the second surface 10S2 at the position y2 by the second cutter 110_2. A portion of the glass layer 13 between the first sub-groove 13a1 and the second sub-groove 13a2 may be removed by allowing the second groove 11g to be overlapped by at least a portion of the first sub-groove 13a1 and at least a portion of the second sub-groove 13a2 in the x direction.

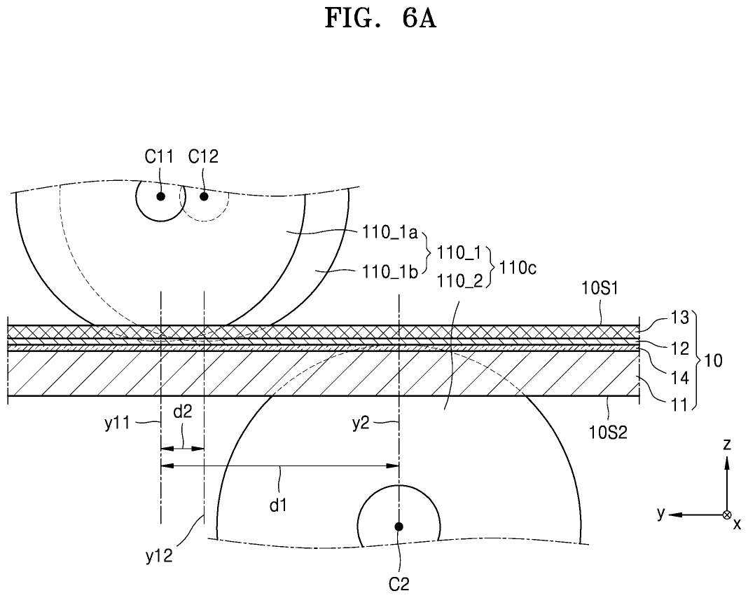

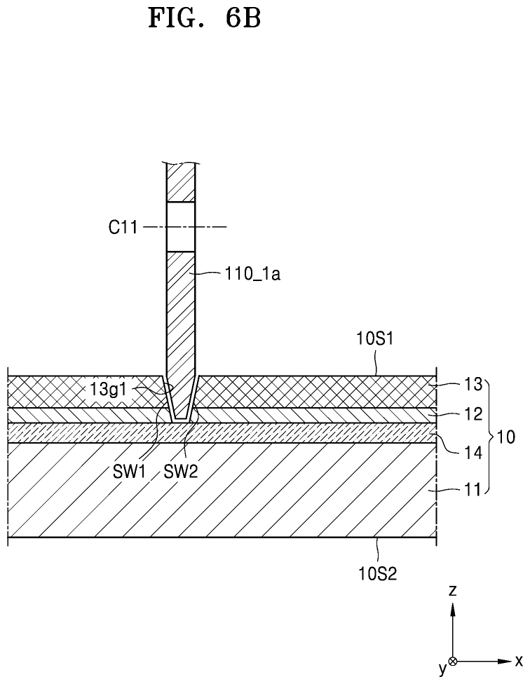

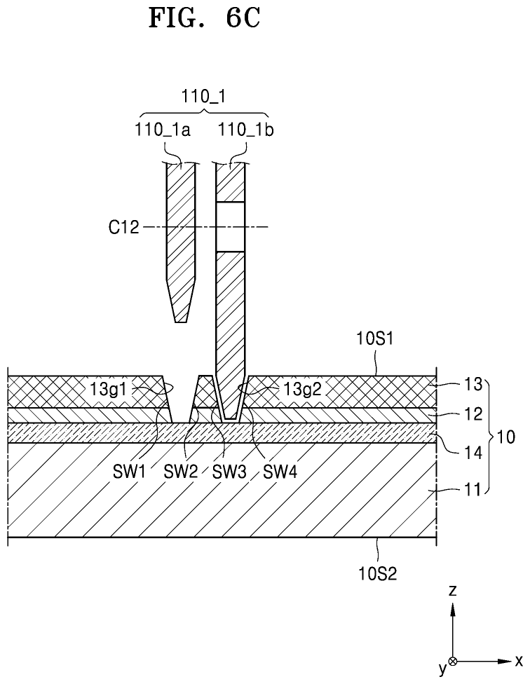

FIG. 6A is a side view illustrating cutting of the glass laminated substrate 10 by a cutter 110c of a cutting apparatus for cutting a glass laminate substrate, according to another embodiment of the present disclosure. FIG. 6B is a cross-sectional view illustrating a cross-section that is parallel to the xz plane at a position y11 of FIG. 6A, and FIG. 6C is a cross-sectional view illustrating a cross-section that is parallel to the xz plane at a position y12 of FIG. 6A.

The cutter 110c according to the embodiment of FIGS. 6A through 6C is different from the cutter 110b described with reference to FIGS. 5A through 5C in that the first sub-cutter 110_1 is positioned ahead compared to the second sub-cutter 110_1b. Accordingly, this difference will now be focused on and described.

Referring to FIGS. 6A through 6C, the first sub-cutter 110_1a is located at the position y11 in the y direction, and the second sub-cutter 110_1b is located at the position y12 in the y direction. In other words, the first sub-cutter 110_1a and the second sub-cutter 110_2b may translate, for example, in the +y direction, and the first sub-cutter 110_1a may be positioned ahead by a distance d2 in the translation direction compared to the second sub-cutter 110_1b.

Referring to FIGS. 6A and 6B, the first sub-groove 13g1 having the first sidewall SW1 and the second sidewall SW2 may be formed to a predetermined depth from the first surface 10S1 at the position y11 by the first sub-cutter 110_1a. The first sub-groove 13g1 may be formed to divide the glass layer 13. The adhesion layer 12 may be partially or completely cut by the first sub-cutter 110_1a.

Referring to FIGS. 6A and 6C, the second sub-groove 13g2 having the third sidewall SW3 and the fourth sidewall SW4 may be formed to a predetermined depth from the first surface 10S1 at the position y12 by the second sub-cutter 110_1b. The second sub-groove 13g2 may be formed to divide the glass layer 13. The adhesion layer 12 may be partially or completely cut by the second sub-cutter 110_1b.

The first sub-cutter 110_1a has already formed the first sub-groove 13g1 and has already proceeded a distance d2 in the translation direction at the position y12, and a rear portion of the first sub-cutter 110_1a may be spaced apart from the first sub-groove 13g1 and may be present on the first sub-groove 13g1.

A cross-section parallel to the xz plane at the position y2 of FIG. 6A is the same as that of FIG. 5C, and thus a detailed description thereof will be omitted.

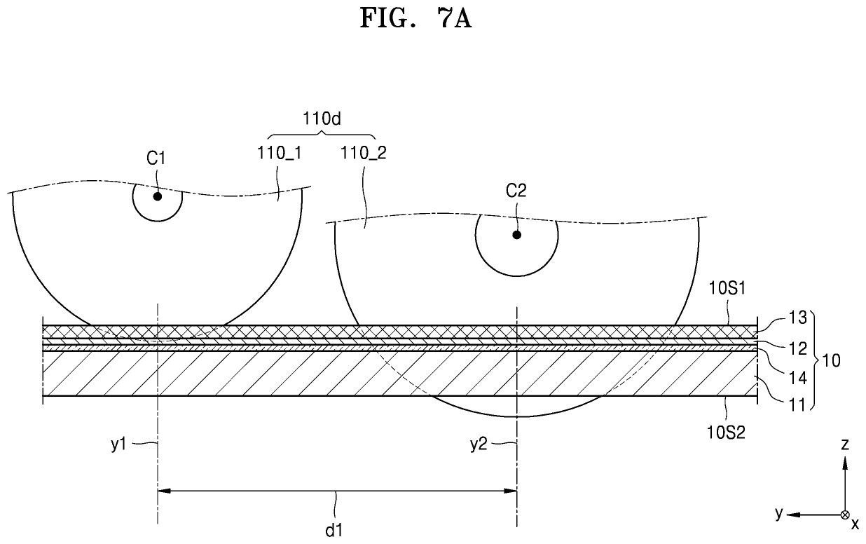

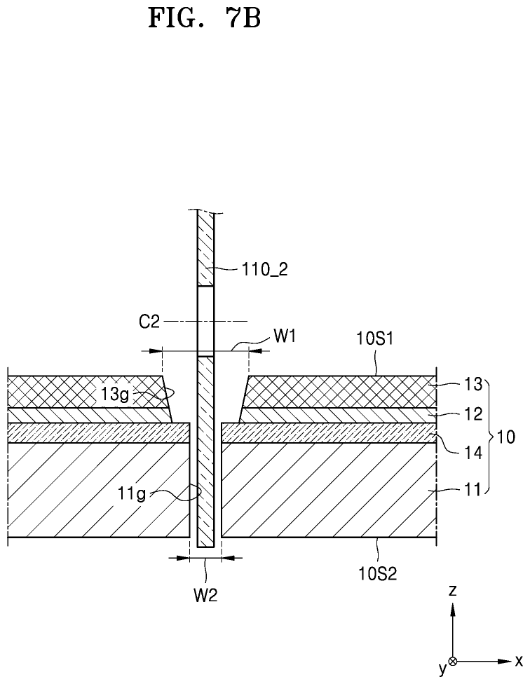

FIG. 7A is a side view illustrating cutting of the glass laminated substrate 10 by a cutter 110d of a cutting apparatus for cutting a glass laminate substrate, according to another embodiment of the present disclosure. FIG. 7B is a cross-sectional view illustrating a cross-section that is parallel to an xz plane at a position y2 of FIG. 7A.

The cutter 110d according to the embodiment of FIGS. 7A and 7B is different from the cutter 110a described with reference to FIGS. 4A through 4C in that the second cutter 110_2 is located on the same side of the glass laminate substrate 10 as the side on which the first cutter 110_1 is positioned. Accordingly, this difference will now be focused on and described.

Referring to FIGS. 7A and 7B, the first cutter 110_1 and the second cutter 110_2 may translate, for example, in the +y direction, and the first cutter 110_1 may be positioned ahead in the translation direction compared to the second cutter 110_2.

A cross-section parallel to the xz plane at the position y1 is the same as that of FIG. 4A, and thus a detailed description thereof will be omitted.

The second groove 11g having the second width W2, which is less than the first width W1, may be formed at the position y2 by the second cutter 110_2, and the second groove 11g may be formed to divide a remaining portion of the glass laminated substrate 10. The second groove 11g may be formed by the second cutter 110_2 passing the first groove 110_1 and cutting the glass laminated substrate 10 from the bottom surface of the first groove 110_1 toward the second surface 10S2.

As shown in FIGS. 7A and 7B, because a shaft C2 of the second cutter 110_2 is positioned above the first surface 10S1, the second cutter 110_2 may proceed in a direction from the first surface 10S1 to the second surface 10S2 (in other words, a −z direction).

As described above, to cut a glass laminated substrate corresponding to a lamination of various materials having different cutting characteristics, a relatively wider groove is formed in a glass layer and a relatively narrow groove is formed in a substrate, and thus generation of glass chips or debris and damage to the glass layer may be greatly reduced.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

1. An apparatus for cutting a glass laminated substrate including a glass layer laminated on a substrate and having a first surface, which is a surface of the glass laminated substrate closer to the glass layer, and a second surface, which is a surface that is opposite the first surface, the apparatus comprising:
a support configured to support the glass laminated substrate;
a first cutter provided to cut the glass layer of the glass laminated substrate; and
a second cutter provided to cut the substrate of the glass laminated substrate,
wherein
the first cutter is configured to form a first groove in the glass laminated substrate, and the second cutter is configured to form a second groove in the glass laminated substrate, and
the first cutter and the second cutter are configured such that an overall width of the first groove is greater than a width of the second groove.

2. The apparatus of claim 1, wherein
the first cutter is configured such that the first groove is formed to be a single groove having a first width, and
the second cutter is configured such that the second groove is formed to have a second width that is less than the first width, the second width being completely overlapped by the first width.

3. The apparatus of claim 2, wherein
the first cutter is configured to form the first groove in the first surface, and
the second cutter is arranged on the same side of the glass laminated substrate as the side on which with the first cutter is arranged.

4. The apparatus of claim 3, wherein the second cutter is configured to pass through the first groove formed by the first cutter, to form the second groove.

5. The apparatus of claim 2, wherein the first cutter and the second cutter are arranged on opposite sides of the glass laminated substrate, respectively.

6. The apparatus of claim 5, wherein
the first cutter and the second cutter are configured to translate in a translation direction relative to the glass laminated substrate, and
the first cutter is positioned ahead of the second cutter in the translation direction.

7. The apparatus of claim 5, wherein
the first cutter and the second cutter are configured to translate in a translation direction relative to the glass laminated substrate, and
the first cutter is configured to translate with the second cutter in the translation direction while being substantially arranged with the second cutter in a direction perpendicular to the first surface.

8. The apparatus of claim 1, wherein the first cutter is configured such that the first groove is formed to have a sidewall that is inclined with respect to the first surface.

9. The apparatus of claim 8, wherein the first cutter is a diamond wheel cutter.

10. The apparatus of claim 1, wherein
the first cutter includes a first sub-cutter configured to form a first sub-groove and a second sub-cutter configured to form a second sub-groove, and
the first cutter and the second cutter are configured such that the first sub-groove and the second sub-groove extend parallel to each other.

11. The apparatus of claim 10, wherein the second cutter is configured such that the second groove is formed to be overlapped by at least a portion of the first sub-groove and at least a portion of the second sub-groove.

12. The apparatus of claim 10, wherein the first sub-cutter and the second sub-cutter are configured to advance side by side at the same position with respect to a direction in which the first cutter proceeds.

13. The apparatus of claim 10, wherein the first sub-cutter and the second sub-cutter are configured to translate at different positions with respect to a direction in which the first cutter proceeds.

14. The apparatus of claim 13, wherein
the first cutter and the second cutter are configured to translate in a translation direction with respect to the glass laminated substrate, and
the second cutter is positioned behind the first sub-cutter and the second sub-cutter in the translation direction.

15. The apparatus of claim 1, wherein relative positions of the first cutter and the second cutter are maintained constant while both the first cutter and the second cutter are cutting the glass laminated substrate.

16. The apparatus of claim 1, wherein
the first cutter is configured to rotate at a rotation speed of about 5000 RPM or less, and
a relative speed of the first cutter and the glass laminated substrate is 2.3 m/minutes or less.

17. (canceled)

18. (canceled)

19. (canceled)

20. (canceled)

21. (canceled)

22. (canceled)
